(19) United States
(12) Patent Application Publication
(10) Pub. No.: US 2004/0065978 A1
(43) Pub. Date: Apr. 8, 2004

(54) Variable thickness sheet extrusion apparatus

(76) Inventor: James Richard Fitzell JR., Flint, MI (US)

Correspondence Address: JAMES RICHARD FITZELL, JR., 900 Fifth Third Center, 111 Lyon Street, N.W., Grand Rapids, MI, 49503-2487, US

(21) Appl. No.: 10/266,215

(22) Filed: Oct. 8, 2002

(51) Int. Cl. B29C 43/46

(52) U.S. Cl. 264/320; 425/328; 425/365; 425/382.3

(57) ABSTRACT

A sheet extrusion apparatus for producing an extruded sheet with varying thickness including one or more sheet rollers and a strip material affixed to one or more of the rollers. The strip material rotates coextensively with the cylinder it is attached to, such that it engages the plastic passing between the rollers and forms a notch in the plastic sheet at that location. In a preferred embodiment, the strip material is a length of conventional tape, such as Teflon tape, that is capable of adhering to both the cylinder and itself, having sufficient durability to last a required amount of cycles. The present invention is easily retrofitted to an existing sheet extrusion apparatus, as the tape can simply be taken off of a shelf and added to the rollers. The present invention is preferably installed after an analysis to determine which sections of the plastic sheet may structurally withstand a reduced thickness.

### BACKGROUND OF THE INVENTION

The present invention relates generally to thermoplastic sheet extrusion, and more particularly to an apparatus and method for varying the thickness of an extruded thermoplastic sheet.

Sheet extrusion is a conventional process for converting plastic, for example, in the form of pellets or powder, into cut sheets or rolls of plastic. The typical extrusion process begins with a hopper that holds the plastic in either powder or granule form. The hopper continuously feeds the material to a conventional extruder. This extruder usually includes a container in which the material is heated and from which it is extruded through a die opening in a continuous flow. The plastic emerges from the die opening with roughly the desired thickness. The plastic is then passed between a number of parallel cylindrical rollers. The rollers further shape the plastic, pressing it into the desired final thickness. The continuous sheet emerges from the rollers and is fed, for example, by a conveyor, to a rolling or cutting station. The plastic may be cooled by fans other cooling apparatus during transfer to the rolling or cutting station to ensure that it retains the desired final thickness. The finished continuous sheet is then rolled into rolls of the desired size or cut into sheets of the desired dimensions.

The thickness of the sheet is generally determined by the spacing between the parallel cylindrical rollers mentioned above. As the heated thermoplastic passes between two rollers, it is formed into a sheet that has a thickness equal to the space between the cylinders. Smooth cylindrical rollers are common and easy to produce, therefore, most sheets are formed with a single, homogeneous cross-section. The cross-sectional thickness of the sheet is usually adjusted by changing the size of the gap between the rollers, either by moving the rollers relative to each other, or by interchanging different sizes of rollers.

Problems arise in sheet extrusion when it is desirable to manufacture a sheet with a variable thickness. Some applications require that a sheet have a varying thickness simply for appearance, while in other cases it may simply be a way to save money by using less thermoplastic material. While it is quite easy and well known in the art to control the thickness of a single thickness sheet, there are many times when required thickness in one area creates an excess of plastic in another. Producing a sheet with variable thickness, however, has generally been too difficult and expensive to be worthwhile. For instance, the common method for manufacturing a variable thickness sheet is to cast unique cylindrical rollers that include varying radii. The radial variations in the rollers correspond to the locations where it is desired to have a variation in sheet thickness. For example, a one inch wide section of increased radius on a cylinder creates a one inch wide notch in the extruded sheet of the same depth as the amount of increased radius. The problem, however, is that the cost of casting new rollers with varying radii is expensive, because of the extra time it takes to design the rollers and create the unique die to cast them. Further, these rollers cannot be easily altered, and are therefore only useful for one specific application. Therefore, in many cases manufacturers are left with no alternative but to manufacture a sheet of a single thickness, even in cases where it isn't needed.

### SUMMARY OF THE INVENTION

The aforementioned problems are overcome by the present invention wherein a sheet extrusion apparatus is provided with one or more sheet rollers and a strip material that is attached to one or more of the sheet rollers. The strip material rotates with the cylinder it is attached to, such that it engages the plastic passing between the rollers and forms a notch in the plastic sheet at that location. The material can be placed on the cylinder in any desired location, and is removable to accommodate any desired change in the location of the notch. The present invention enables cost effective thermoforming of a plastic sheet with variable thickness.

In a preferred embodiment, the strip material is a length of conventional tape material that is capable of adhering to both the cylinder and to itself and that has sufficient durability to last a required amount of cycles, such as Teflon tape. The tape is preferably wrapped concentrically around the cylinder, with each wrap of the tape increasing the radius of the cylinder at that particular section. Functionally, the tape will contact the thermoplastic as it passes between the rollers, and form a notch in the thermoplastic at that point running the length of the sheet. The depth of the notch is directly related to the number of times the tape has been wrapped around the roller, with more wraps producing a deeper notch. If multiple notches are desired, any number of tape sections can be added. Further, each notch can have a unique depth. Alternatively, the tape may be disposed axially on the length of the cylinder, creating notches in the extruded plastic sheet at every revolution of the cylinder.

In another preferred embodiment, the extrusion apparatus includes three parallel cylindrical rollers. The rollers are spaced equally, at distances equal to the desired nominal sheet thickness. The plastic sheet is fed through a first gap, then around the middle roller and through a second gap. The strip material is preferably attached to the center roller, so that it contacts the plastic for the longest period of time, but may be attached to any combination of rollers.

The present invention is preferably installed after an analysis to determine which sections of the plastic sheet may structurally withstand a reduced thickness. One common analysis tool is finite element analysis, which can pinpoint the structural requirements of each section of the sheet after the sheet's final application is known. Alternatively, locations of reduced thickness may be chosen simply from experience in field of thermoplastics, or for aesthetic purposes.

The present invention also provides a method for extruding sheets of plastic having a variable thickness. The method generally includes the steps of (a) locating the desired sections for reduced thickness on a plastic sheet, (b) attaching a strip material to one or a number of sheet rollers of a sheet extrusion apparatus, (c) wrapping the strip around the roller until it reaches a desired thickness, and (d) pressing a heated thermoplastic material between the rollers, such that the strip material contacts the thermoplastic and forms a notch at that location.

The present invention provides a simple and effective mechanism for producing an extruded sheet of varying thickness. The present invention is easily retrofitted to an existing sheet extrusion apparatus, as the strip material can be added to nearly any type of existing roller. No permanent changes to the extrusion apparatus are required. If a single thickness sheet is desired after the addition of the strip material, the strip material can simply be removed from the cylinders—a great time and cost savings over conventional methods. Likewise if additional notches are desired, or if the notch locations need to be changed, new tape can easily be added, or existing tape can be moved. In addition, the present invention is cost effective. The cost savings between casting an entire set of unique rollers to accomplish a task, as opposed to simply grabbing a roll of tape off the shelf and adding it to an existing roller is enormous.

These and other objects, advantages, and features of the invention will be readily understood and appreciated by reference to the detailed description of the preferred embodiment and the drawings.

### BRIEF DESCRIPTION OF THE DRAWINGS

FIG. 1 is a perspective view of a sheet extrusion apparatus in the preferred embodiment of the present invention.

FIG. 2 is an enlarged perspective view of the of the present invention.

FIG. 3 is a side view of the rollers, strip material, and thermoplastic, with the rest of the extrusion apparatus removed.

FIG. 4 is a rear sectional view of the rollers, strip material, and thermoplastic along line A-A, with the rest of the extrusion apparatus removed.

FIG. 5 is a enlarged rear sectional view of the top two rollers, strip material, and thermoplastic in the preferred embodiment.

FIG. 6 is a perspective view of a roller having strip material extending in a radial direction.

FIG. 7 is a sectional view showing a portion of a roller with strip material in an alternative arrangement.

### DETAILED DESCRIPTION OF THE PREFERRED EMBODIMENT

I. Overview

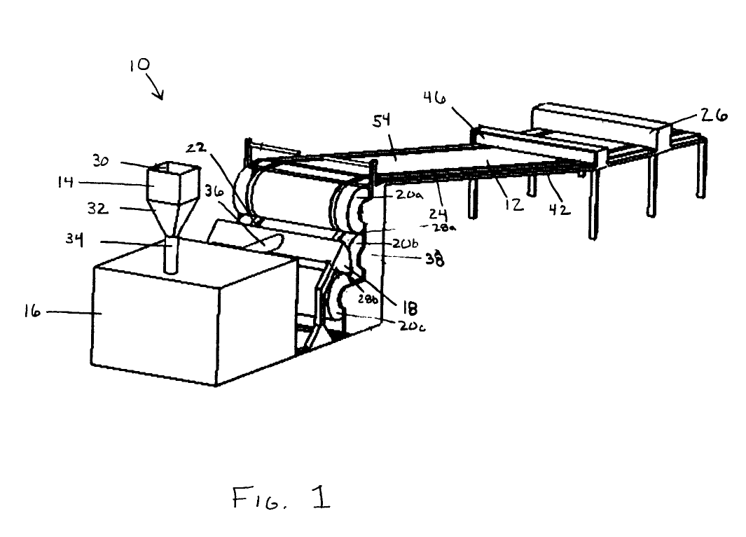

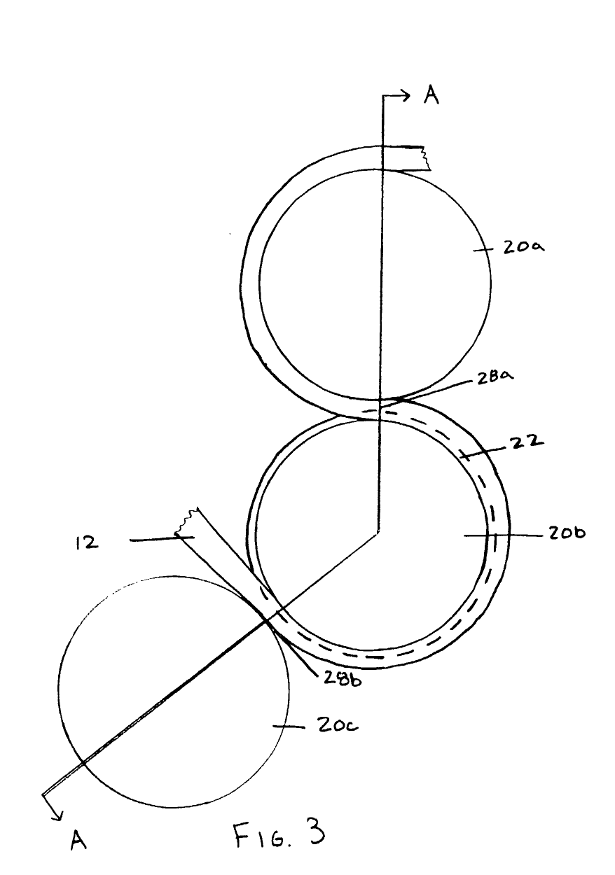

A thermoforming sheet extrusion system in accordance with a preferred embodiment of the present invention is shown in FIG. 1 and generally designated 10. The sheet extrusion system 10 is preferably configured to form a thermoplastic material 12 into sheets by melting the plastic material 12 and then extruding and shaping the melted plastic material 12 so that it cools in a continuous sheet form. The sheet extrusion system 10 preferably includes a hopper 14 that receives the raw plastic; an extruder 16 that heats the plastic and extrudes it through a die opening 18; a set of three rollers 20a-c for pressing the plastic 12 to the proper thickness; a strip material 22 attached to the rollers 20a-c providing a variable thickness sheet; and a conveyor 24 and cutter 26 for cooling the plastic 12 and cutting it into sections. In operation, plastic 12 in the form of pellets or granules is placed in the hopper 14. The plastic 12 is then automatically transferred into the extruder 16. The extruder 16 heats and mixes the plastic and forces it out the die opening 18 in melted form. Once out of the die opening 18, the plastic is fed between two of the parallel cylindrical rollers 20a-c, with at least one of the rollers 20a-c having a strip material 22 attached, such that the plastic 12 is pressed to the thickness of the roller gaps 28a-b (shown in FIG. 3), with a reduced thickness at the location(s) of the strip material 22. The formed plastic sheet 12 is then cooled as it is pulled down a conveyor 24 and then cut into desired lengths or rolled into a roll of the desired length.

II. Structure

As noted above, the system 10 preferably includes a hopper 14 and extruder 16 for accumulating, melting and extruding the thermoplastic material. In the embodiment illustrated in FIG. 1, the hopper 14 and extruder 16 are generally conventional. As shown in FIG. 1, the hopper 14 is generally a basket with an open top 30 and a funnel shaped bottom 32 that forms a tube 34 leading into the extruder 16. The extruder 16 is generally barrel shaped and contains complex inner mechanisms (not shown) for heating and mixing the plastic and forcing it out the die opening 18. The hopper 14 and extruder 16 are generally conventional and therefore will not be discussed in further detail here. Although the present invention is described in connection with a conventional hopper and extruder, the present invention is well suited for use with other conventional apparatus for collecting, heating, and extruding thermoplastic.

As noted above, the system 10 the extruder 16 extrudes the melted plastic into a die opening 18. The die opening 18 provides the melted thermoplastic with the desired initial shape. In the illustrated embodiment, the die opening 18 is connected to the extruder 16 by a tube 36. The die opening 18 is generally conventional, and therefore will not be discussed in detail here. Briefly, the die opening 18 has a shape that is approximate to the desired cross section of the plastic sheet 12. The melted plastic 12 is forced from the extruder 16 through the tube 36, then through the die opening 18, wherein it begins to take the form of a plastic sheet. The die opening 18 may include a plurality of conventional adjustment screws that permit fine control over the size and shape of the opening through which the melted plastic is extruded, and hence over the initial shape of the extruded sheet.

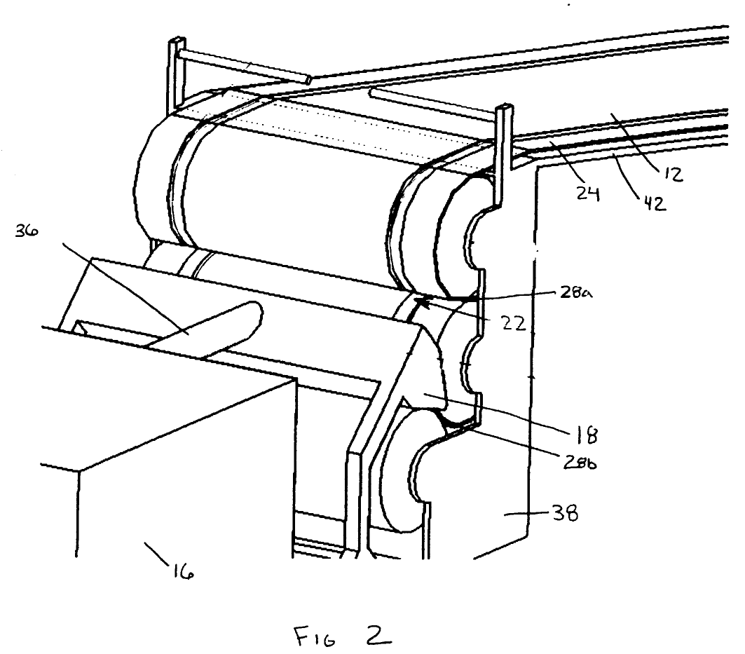

In the illustrated embodiment, a plurality of sheet rollers 20a-c are positioned adjacent to the die opening 18 to further shape the extruded sheet as it passes from the die opening 18. In the illustrated embodiment, the present invention includes three parallel cylindrical rollers 20a-c, which press the plastic 12 and provide the desired sheet thickness. The cylindrical rollers 20a-c are typically, and preferably, cast (or otherwise formed) from stainless steel, but may be made from any appropriate material. Referring to FIGS. 1 and 2, the rollers 20a-c are supported on a conventional roll stand 38 by conventional axles (not shown). Shown in FIG. 3, rollers 20a and b are vertically disposed, such that roller 20a is positioned directly above roller 20b. Roller 20c is offset from rollers 20 a and b, such that it is diagonally lower and in front of roller 20b. Referring now to FIG. 2, rollers 20b and c are disposed such that the gap 28b between them is directly below the die opening 18. The rollers 20a-c are preferably spaced apart evenly, forming two roller gaps 28a and b, including a lower gap 28b between rollers 20b and 20c, and an upper gap 28a between rollers 20a and 20b. The size of the gaps 28a and b is determined by the desired nominal thickness of the plastic sheet 12. Conventional drive motors (not shown) provide the rollers 20a-c with constant and uniform rotation, in order to continually pull the thermoplastic 12 through the roller gaps 28a and b. Although the present invention is described in connection with a system having three sheet rollers, the present invention may include a different number of rollers as desired in the specific application. For example, in some applications only two rollers are required to provide sheet of acceptable quality, while in other applications, four or more rollers may be included to provide a sheet meeting more precise tolerances.

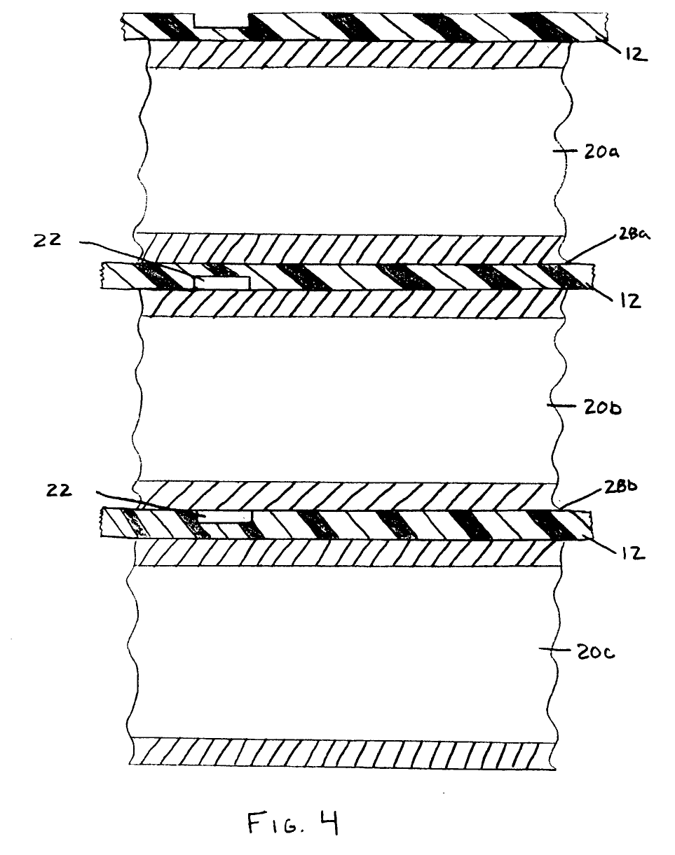

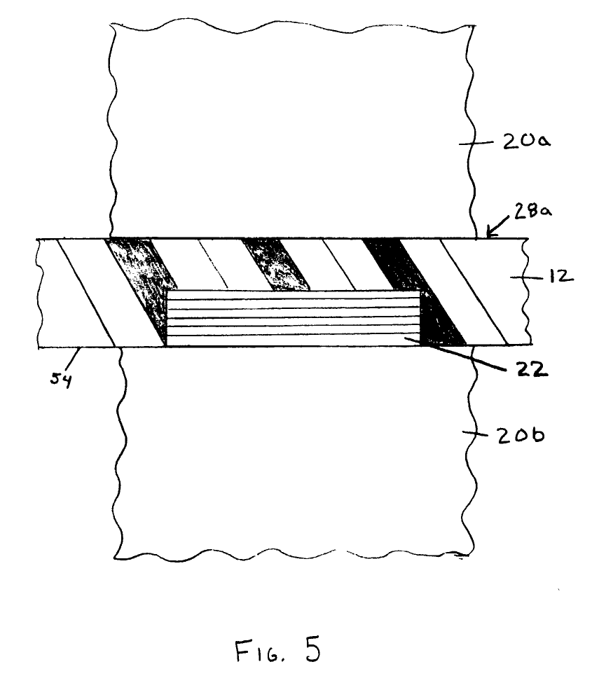

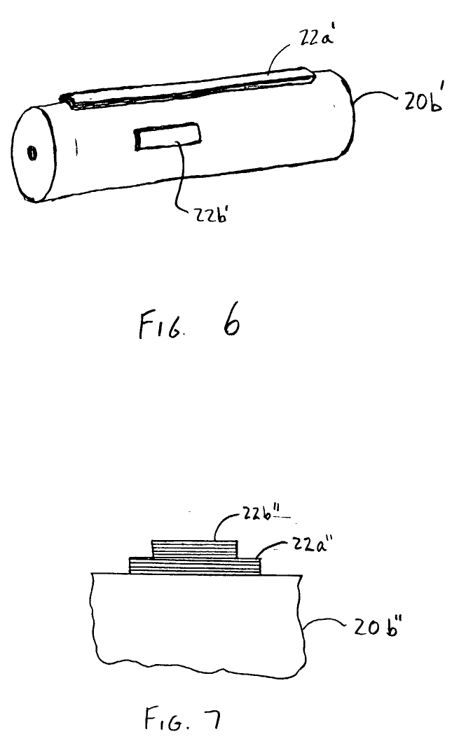

The present invention includes a strip material 22 that is affixed to one or more of the sheet rollers 20a-c to provide local variations in the thickness of the extruded sheet. The strip material 22 is preferably attached to one or more of the rollers 20a-c. The strip material 22 is preferably a conventional thin, flexible material that can be easily affixed to a sheet roller, for example, by wrapping the material around the roller. The strip material may be a thermoplastic material that adheres to itself in response to the heat and pressure of the sheet-forming process. The strip material may also be a tape, such as Teflon tape, having an adhesive material on one side to facilitate attachment to one or more of the rollers. In the illustrated embodiment, the tape 22 is wound circumferentially around the center roller 20b, but it may alternatively be attached to any of the rollers 20a-c in any desired combination. As the tape 22 is wound around one of the rollers 20a-c it adheres to the roller 20a-c and itself and continually increases the thickness of the roller 20a-c. FIG. 5, a close-up view of the tape 22, plastic 12, and rollers 20a and b, shows a strip material 22 that has been wound 6 times as an example of how the desired thickness is achieved. The tape 22 may be wound as many times as needed to achieve the desired thickness. The tape 22 is also removable, such that it may be unwound from the roller 20a-c after a length of time. FIGS. 1 and 2 show examples of the present invention including a strip material 22 at two locations, whereas FIGS. 4-5 show a strip material at only one location. A preferred embodiment of the present invention may include any number of locations of strip material, wrapped to any thickness, depending on the desired thickness of the sheet 12. Although the strip material is preferably wrapped circumferentially around the surface of the roller, it may alternatively be affixed to the surface in other orientations. For example, FIG. 6 shows two segments of radially-extending strip material 22a′and 22b′ affixed to the surface of the roller 20b′ In this alternative embodiment, the reduced thickness regions will occur at even intervals in the sheet depending on the diameter of the roller. As an additional alternative, strip materials of different widths can be employed to provide notches of different shapes. In some applications, strip materials of different widths can be wrapped around a roller at the same location to provide a “stepped” notch. For example, a three inch wide tape 22a″ can be wrapped around the roller 20b″ to a height of one quarter inch and then a two inch wide tape 22b″ can be wrapped around the roller 20b″ atop the three inch tape to a height of one half inch (See FIG. 7). The strip material may also be applied to a pair of opposed rollers so that notches are formed in both sides of the resulting sheet.

In one embodiment, the roll stand 38 is connected to a table 42 for feeding the continuous sheet away as it emerges from the roller assembly. The table 42 preferably includes a plurality of horizontally disposed feed rollers (not shown). The table 42 is preferably adjacent to roller 20a and set to a height that is even with the top of the roller 20a, such that the sheet 12 coming off the roller 20a will travel directly onto the table 42. A pull roller 46 and cutter head 26 are located on the table 42 at a distance from the roll stand 38. These mechanisms are generally conventional in the art of sheet extrusion, and therefore will not be discussed in detail here. Briefly, the pull roller 44 is a cylindrical roller disposed vertically above one of the feed rollers, provided with rotation from a conventional drive motor (not shown). The cutter 48 is generally a blade that sits above the table 42, spanning the width of the table 42 and provided with actuation such that it can translate down to contact the table 42 and cut the plastic sheet 12. In some applications, the sheet material may be rolled into rolls of desired length, rather than cut into separate sheets. A variety of conventional apparatus is available for rolling the sheet material into rolls.

III. Operation

In operation, the first step is to determine the desired locations for reduced thickness along the length of the plastic sheet 12. Preferably, this consists of performing an analysis, such as finite element analysis, of a thermoplastic sheet in its final application. The analysis breaks the sheet down into small sections, and simulates the forces that will be exerted on each section. If the results of the analysis show that a certain section of the sheet will receive relatively low stress, then it will be desirable to have a reduced thickness at that section. The amount of reduced thickness will be determined accordingly. For applications in which the strip material is wrapped concentrically about the sheet rollers, the analysis will preferably disclose a line where reduced thickness is permissible along a line passing fully across the sheet in the direction of extrusion.

Once the locations of reduced thickness have been determined, plastic material 12 in pellet or granule form is loaded into the upper end 30 of the hopper 14. The plastic 12 falls through the hopper funnel 32 and tube 34 into the extruder 16. Inside the extruder 16, the plastic 12 is heated above its glass transition temperature and mixed into a molten form. The molten plastic 12 is then forced through the extruder tube 36 and die opening 18. At the die opening 18, the plastic 12 takes the shape of the die 18, forming a sheet of plastic 12 with an upper surface 54 and opposing lower surface (not shown).

After exiting the die opening 18, the plastic 12 enters the lower roller gap 28b, wherein the rotation of the rollers 20b and 20c pull the material 12 through the gap 28b to further shape the cross section of the sheet 12. The center roller 20b includes a strip material 22 that has been wrapped around the roller 20b a predetermined number of times according to the results of the aforementioned analysis, increasing the radius of the roller 20b by a desired amount in that location. The strip material 22 engages the upper surface of the plastic 54 as it contacts the roller 20b and passes through the gap 28b, forming a notch in the upper surface 54 at the location of the strip material 22. The depth of the notch is equal to the thickness of the strip material 22.

After the plastic exits the lower gap 28b, the upper surface 54 remains in contact with the center roller 20b and strip material 22, and the plastic 12 is carried around roller 20b and into the upper gap 28a. The plastic 12 then passes through the upper gap 28a, and is carried around the upper cylinder 20c to the table 42. FIG. 5 shows a view of the plastic 12 at this stage, wherein it passes between upper rollers 20a and b, continuing to engage the strip material 22. Once the sheet 12 has reached the table 42, the notch(es) on the upper face 54 of sheet 12 are facing vertically upward, away from table 42. The plastic 12, now in sheet form with the desired cross-sectional dimensions, cools and hardens as it is fed down the table 42 on small rollers 44 with the upper surface 54 including the notch(es) exposed. Finally, the sheet 12 passes under the cutter blade 48, which cuts the plastic 12 manually or automatically into desired lengths.

IV. First Alternative Embodiment

In an alternative embodiment of the present invention, the strip material 22 is added to rollers 20a and 20c, such that all three rollers 20a-c are provided with a strip material 22. The sheet extrusion method is the same as in the preferred embodiment, except that the plastic 12 now engages strip material 22 from each roller 20a-c that it contacts. The result of having strip material 22 on all three rollers 20a-c is that the both the upper 54 and lower surfaces engage the plastic 12, forming notches in both surfaces at the locations of the strip material 22.

V. Second Alternative Embodiment

In another alternative embodiment, the strip material 22 is attached lengthwise on one or more of the cylindrical rollers 20a-c. The result of this placement is that a notch the entire length of the strip material 22 is formed in the plastic sheet 12 for each revolution of the cylinder(s). The frequency of the notches depends upon the size of the rollers 20a-c, for instance, a smaller roller produces more revolutions and therefore more closely spaced notches. Multiple segments of strip material can also be added to one or more of the rollers 20a-c to provide separate notches in the extruded sheet.

As an alternative option, the strip material can be configured to provide raised or recessed lettering, logos, instructions, insignia or other graphics in the manufactured sheet. For example, the strip material may be die cut, laser cut or otherwise shaped to provide a finished sheet with a customer's logo or trademark. In one embodiment, a first strip material can be used to build up a base portion on the roller. This first material is preferably a relatively thin, flexible, tape material, such as the Teflon tape discussed above, that is layered repeatedly over the roller to build a raised portion that is equal to the desired variation in the overall thickness in the sheet at that location minus the desired thickness of the raised or recessed graphics. A second strip material having a thickness that corresponds to the desired height or depth of the raised or recessed graphics can then be layered on the roller atop the first strip material. The second strip material is preferably die or laser cut to define the desired graphics and then secured to the first strip material. For example, the second strip material may be cut to form discrete letters that are secured atop the first strip material by an adhesive. During manufacture, the raised letters define corresponding recessed letters in the sheet material. As an alternative example, the second strip material may be laser cut to define voids in the shape of the desired graphics. The second strip material is preferably secured to the first strip material, for example, by adhesive. During manufacture, the voids define corresponding raised graphics. As an alternative to using a single, relatively thick layer of strip material to define the raised or recessed graphics, a plurality of layers of a relatively thin strip material may be used where each layer is pre-cut or otherwise pre-shaped to define the desired graphics. For example, this can be achieved with a strip material in which the desired cut-outs are repeated along the length of the strip material In applications where the strip material is wrapped around the roller, the spacing of the cut-outs along the length of the strip is preferably set as a function of the diameter of the roller and the thickness of the strip material so that the graphics properly align with each successive layer. Although the strip material is preferably pre-cut or otherwise pre-shaped to provide the desired raised or recessed graphics, the strip material may alternatively be cut after application to the roller.

The above description is that of the preferred embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An apparatus for producing a sheet of thermoplastic with variable thickness, comprising:
a plurality of rollers, wherein the thermoplastic material will pass between a pair of said rollers to be formed into a sheet; and
a strip material attached to at least one of said rollers, said strip material engaging the thermoplastic at a predetermined location to create a variation in the thickness of said sheet.

2. The apparatus of claim 1 wherein said rollers are parallel and cylindrical.

3. The apparatus of claim 1 wherein there are three of said rollers, such that the thermoplastic is pressed twice.

4. The apparatus of claim 3, wherein said strip material is attached solely to the center roller to maximize the duration of contact with said roller.

5. The apparatus of claim 1 wherein said rollers are spaced apart evenly, said spacing equal to the desired nominal thickness of said sheet.

6. The apparatus of claim 1 wherein said strip material is a strip of conventional Teflon tape.

7. The apparatus of claim 1 wherein said strip material is concentrically wound around at least one of said rollers with enough revolutions to achieve the desired thickness variation in the thermoplastic.

8. The apparatus of claim 7 wherein said strip material includes an adhesive material disposed on at least one side, such that said strip material is capable of adhering to itself and to said roller.

9. A method for forming a thermoplastic sheet of variable thickness, comprising:
determining one or more desired locations for varying the thickness of a thermoplastic sheet;
attaching a strip material to at least one of a plurality of sheet rollers in a sheet producing apparatus; and
pressing the thermoplastic material between at least one pair of said rollers with the thermoplastic material being engaged by said strip material, such that the strip material contacts forms a reduced thickness in the thermoplastic material at the location.

10. The method of claim 9 wherein said attaching step includes wrapping the strip material around a roller until the thickness of said strip material is sufficient to create the desired reduced thermoplastic thickness.

11. The method of claim 10 wherein the sheet producing apparatus includes three sheet rollers, said attaching step including wrapping the strip material around a center roller of the three rollers.

12. The method of claim 9 wherein said strip material is a conventional Teflon tape.

13. The method of claim 9 wherein an adhesive material is disposed on one side of said strip material, such that said strip material can adhere to said roller and itself.

14. A thermoplastic sheet having a variable thickness, produced by the process of:
locating a section along the length of a thermoplastic sheet that is desirable for having a thickness that is thinner than the nominal sheet thickness;
providing a strip material attached to at least one of a set of two or more sheet rollers, said sheet rollers for pressing the thermoplastic into sheet form, said strip material increasing the thickness of said rollers for pressing said desired sections of said thermoplastic into a reduced thickness, said reduced thickness less than the nominal thickness of said sheet form;
extruding the thermoplastic material into an initial sheet-like form;
pressing said thermoplastic sheet-like form between at least two of said rollers to form said sheet, said strip material engaging said thermoplastic sheet-like form to provide said sheet-like form with a section of reduced thickness.

15. The process of claim 14, wherein said strip material is wound around the circumference of at least one of said rollers.

16. The process of claim 14 wherein said strip material is wound around said roller until the thickness of said strip material will form the desired reduced thickness in said thermoplastic at the point of contact between said strip material and said thermoplastic.

17. The process of claim 14 wherein said sheet extruding apparatus includes three of said rollers, said rollers being arranged adjacent to one another wherein thermoplastic is pressed between a first of said rollers and a second of said rollers then continues to wind around said second of said rollers and is pressed between said second of said rollers and a third of said rollers.

18. The process of claim 17 wherein said strip material is disposed on said second of said rollers, such that the thermoplastic contacts said strip material when it enters a gap between said first of said rollers and said second of said rollers until it leaves a gap between said second of said rollers and said third of said rollers.

19. The process of claim 14 wherein said strip material is a conventional tape.

20. The process of claim 19 wherein said tape includes an adhesive material on one side, such that when wound around a roller said tape adheres to said roller and said tape.

21. A sheet forming apparatus comprising:
a thermoplastic extruder for extruding a melted thermoplastic material;
a die opening for shaping said melted thermoplastic material into an initial sheet-like form;
a plurality of rollers for shaping said initial sheet-like form into a final sheet, said plurality of rollers including at least two rollers spaced apart to define a gap, said gap receiving said sheet-like form and being dimensioned to press said sheet-like form into a desired shape; and
a strip material affixed to at least one of said rollers at a location, said strip material being carried by and rotating with said roller to which is is affixed, whereby said strip material passes through said gap to press a portion of said sheet-like form to provide a final sheet with a reduced thickness portion corresponding to said location.

22. The sheet forming apparatus of claim 21 wherein said strip material includes a flexible material affixed to a surface at least one of said rollers.

23. The sheet forming apparatus of claim 22 wherein said strip material is further defined as a polymeric material.

24. The sheet forming apparatus of claim 21 wherein said strip material is further defined a thin, flexible material that is layered on a surface of at least one of said rollers.

25. The sheet forming apparatus of claim 24 wherein said strip material is wrapped repeatedly around at least one of said rollers.

26. The sheet forming apparatus of claim 21 wherein said plurality of rollers includes three rollers, said rollers being arranged adjacent to one another to define a first gap between a first of said rollers and a second of said rollers and a second gap between said second of said rollers and a third of said rollers, said sheet-like form passing through said first gap and said second gap.

27. The sheet forming apparatus of claim 26 wherein said strip material is affixed to said second of said rollers, said sheet-like form maintaining contacting with said strip material from a time when it enters said first gap to a time when it exits said second gap.

28. The sheet forming apparatus of claim 27 wherein said strip material is Teflon tape.

29. The sheet forming apparatus of claim 21 wherein said strip material includes a graphics portion configured to define raised or recessed graphics in the final sheet.
